(19) United States
(12) Patent Application Publication
(10) Pub. No.: US 2023/0108788 A1
(43) Pub. Date: Apr. 6, 2023

(54) ASSEMBLY COMPRISING TWO CONCENTRIC TUBULAR PORTIONS AND A SET OF SENSORS FOR SENSING THERMAL FLOW INSIDE THE OUTER TUBULAR PORTION

(71) Applicant: Airbus Operations SAS, Toulouse (FR)

(72) Inventor: Christian FLEMIN, TOULOUSE (FR)

(21) Appl. No.: 17/958,565

(22) Filed: Oct. 3, 2022

(30) Foreign Application Priority Data
Oct. 6, 2021 (FR) 2110593

(51) Int. Cl. F01D 21/12; F01D 25/14; F01D 9/06

(52) U.S. Cl. CPC F01D 21/12; F01D 25/145; F01D 9/06; F05D 2220/323; F05D 2260/231; F05D 2260/80; F05D 2300/5024; F05D 2270/3032

(57) ABSTRACT

An assembly having an outer tubular portion delimiting an inner space, an inner tubular portion in the outer tubular portion, a fluid jacket in the inner tubular portion, a plurality of groups of at least four thermal flow sensors. For each group, the sensors of the group are disposed in the inner space and overall in one and the same plane perpendicular to a central line. In each group, the sensors of the group are distributed angularly about the central line. A control unit which, for each group, receives the data from each sensor of the group and which, on the basis of these data, determines a warning level. With such an arrangement, the monitoring of the values of the different thermal flow sensors makes it possible to monitor a potential problem at the fluid jacket.

### CROSS-REFERENCES TO RELATED APPLICATIONS

This application claims the benefit of the French patent application No. 2110593 filed on Oct. 6, 2021, the entire disclosures of which are incorporated herein by way of reference.

### FIELD OF THE INVENTION

The present invention relates to an assembly which has two concentric tubular portions and a fluid jacket, and a set of thermal flow sensors which are distributed inside the outer tubular portion, and also to an aircraft having at least one such assembly.

### BACKGROUND OF THE INVENTION

An aircraft conventionally has at least one jet engine, which has an engine forming a core around which are arranged an internal fixed structure surrounding the engine, and outer cowls disposed around the internal fixed structure.

The internal fixed structure is in the overall shape of a cylinder of revolution, inside which circulates a fluid, for example in the form of a gas and/or liquid, and it is generally divided into two half-cylinders mounted on a pylon of the aircraft.

The internal fixed structure acts, inter alia, as a thermal barrier with respect to the other elements of the jet engine that are disposed outside the internal fixed structure.

To detect the outbreak of a fire or abnormal heating inside the internal fixed structure, it is known to use sensors for sensing overheating or a fire (also known as “fire loops”), which are distributed at different locations in the jet engine.

To detect an overpressure during a ramp inspection and potentially a rupture at a part of the internal fixed structure, it is known to use specific sensors which are known as “pressure relief doors” and “burst duct detection devices” and which are relatively heavy and bulky and do not always provide continuous monitoring.

Even though these elements provide good results, it is necessary to find an arrangement which makes it possible, inter alia, to limit the weight of the sensors for example to save fuel, reduce the cost of the sensors, and to improve the constraints relating to the operability and maintenance of such an arrangement.

In order to monitor the operating state over time (also known as “health monitoring”) of the internal fixed structure and of the engine, it is known to use a set of specific sensors, such as temperature sensors, pressure sensors, flow rate measuring devices or vibration sensors. However, the utilization of the measurements output by these different sensors is complex and not very precise.

Moreover, an aircraft having an engine that operates on the basis of dihydrogen has an internal fixed structure that acts as a dihydrogen tank, and pipes which connect the dihydrogen tank to the engine and which are subject to cryogenic temperatures and high pressures.

It is, therefore, important to be able to rapidly detect any leaks of dihydrogen from the tank or the pipes, and to locate them precisely. To that end, it is necessary to employ numerous temperature and pressure sensors, and flow rate measuring devices.

Even though these elements provide good results, it is necessary to find an arrangement which makes it possible, inter alia, to locate and quantify the leaks during the use of the aircraft, to limit the weight and cost of the sensors, and to improve the constraints relating to the operability and maintenance of such an arrangement.

The document US2017/096238 describes a propulsion system comprising a nacelle of tubular shape delimited by internal and external walls, a jet engine situated inside the inner wall of the nacelle, and a plurality of fire sensors distributed in the propulsion system and connection to a detection unit. When a fire sensor detects a fire in the propulsion system, the fire sensor informs the detection unit, which triggers a warning means present in the cockpit.

### SUMMARY OF THE INVENTION

An object of the present invention is to propose an assembly which has two concentric tubular portions and a fluid jacket and a set of thermal flow sensors which are distributed between the two tubular portions.

To this end, an assembly in an aircraft is proposed, comprising:
an outer tubular portion that is centered on a central line and delimits an inner space,
an inner tubular portion that is mounted coaxially with the outer tubular portion and inside the outer tubular portion, wherein the inner tubular portion contains a fluid exhibiting a temperature referred to as “second temperature”,
a fluid jacket that is mounted coaxially with the outer tubular portion and inside the inner tubular portion, wherein the fluid jacket contains a fluid exhibiting a temperature referred to as “first temperature” and wherein the first temperature is different from the second temperature,

wherein the assembly also comprises:
a plurality of groups of at least four thermal flow sensors, wherein, for each group, the sensors of the group are disposed in the inner space of the outer tubular portion and overall in one and the same plane perpendicular to the central line, and wherein, in each group, the sensors of the group are distributed angularly about the central line, and
a control unit which, for each group, receives the data from each sensor of the group and which, on the basis of these data, determines a warning level that relates to the assembly, the control unit having:
collecting means which are configured to collect, for each group of sensors, the value that relates to the thermal flow passing through each sensor of the group at a time ‘t’ and is transmitted by the sensor,
first calculation means which are configured to calculate, for each group, a so-called “group” average, which is the average of the values thus collected for the group,
second calculation means which are configured, for each group and for each sensor of the group, to calculate the difference between the value of the sensor and the group average and the ratio between this difference and the group average, and
classification means which are configured, for each group and for each sensor of the group, to classify the warning level of the sensor into a category depending on the ratio thus calculated for the sensor.

The groups of sensors thus form a detection network.

With such an assembly, the monitoring of the values of the different thermal flow sensors makes it possible to monitor a potential problem at the fluid jacket, such as a leak of fluid, a potential outbreak of fire or a potential overpressure, with a saving of weight compared with the prior art. This assembly also allows an improvement in the detection of a potential problem at the fluid jacket in terms of reliability, of detection time and of location of the problem, and a reduction in the investigation time on the ground in order to locate the problem, and better monitoring if a problem arises.

Advantageously, the control unit has determination means which are intended to determine, for each group, the maximum value and the minimum value of the values collected for the group, and the first calculation means are intended to calculate the group average on the basis of the set of values of the group without the maximum value and the minimum value.

According to one particular embodiment, the sensors are fixed to the inner tubular portion.

According to one particular embodiment, the inner tubular portion is made of a thermally insulating material with a thermal conductivity of less than 0.2 Wm−1K−1.

According to one particular embodiment, the assembly is a jet engine of an aircraft, wherein the fluid jacket is an engine channeling a flow of hot gas, and wherein the outer tubular portion and the inner tubular portion respectively constitute an external wall and an internal wall of an internal fixed structure.

According to one particular embodiment, the assembly is a pipe, wherein the fluid jacket channels a pressurized fluid.

According to another particular embodiment, the assembly is a storage tank for a pressurized fluid, wherein the fluid jacket is configured to contain a pressurized fluid.

The pressurized fluid may be a hot or cold gas or liquid.

The invention also proposes an aircraft having at least one assembly according to one of the above variants.

### BRIEF DESCRIPTION OF THE DRAWINGS

The features of the invention mentioned above, along with others, will become more clearly apparent upon reading the following description of an exemplary embodiment, the description being given with reference to the appended drawings, in which:

FIG. 1 is a side view of an aircraft according to the invention,

FIG. 2 is a schematic depiction in cross section on the line II-II in FIG. 1 of an internal fixed structure of a jet engine according to one embodiment of the invention,

FIG. 3 is a view in cross section on the line III-III of the internal fixed structure in FIG. 2,

FIG. 4a is a frontal view of an assembly in the form of a pipe according to another embodiment of the invention,

FIG. 4b is a frontal view of an assembly in the form of a tank according to another embodiment of the invention, and

FIG. 5 shows an example of the architecture of a control unit employed in an assembly according to the invention.

### DETAILED DESCRIPTION OF THE PREFERRED EMBODIMENTS

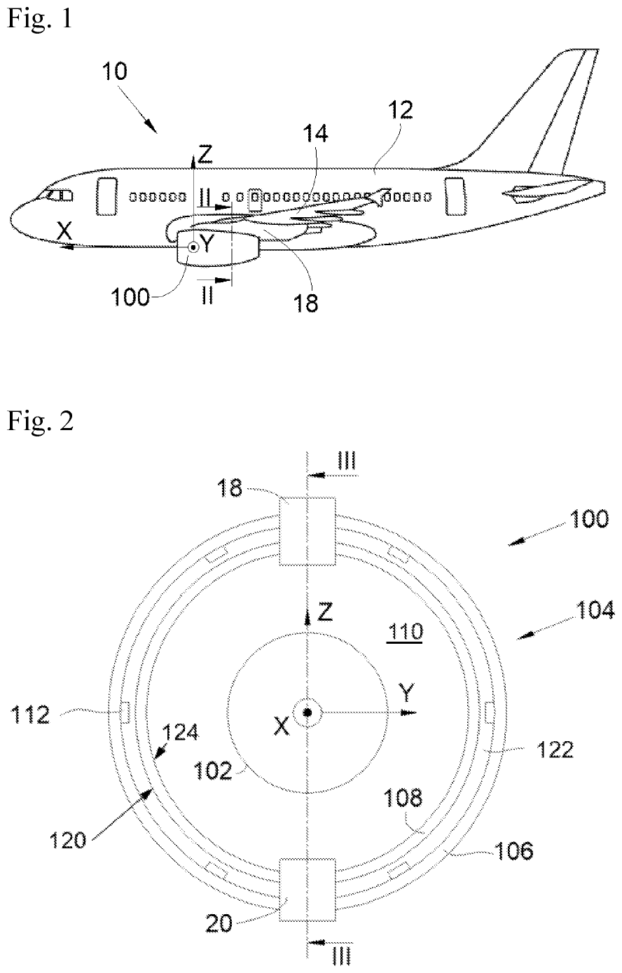

FIG. 1 shows an aircraft 10 which has a fuselage 12, to each side of which is fastened a wing 14 which bears at least one jet engine 100, in particular a turbofan, and a pylon 18 which fastens the jet engine 100 beneath the wing 14.

In the following description, and by convention, X denotes the longitudinal axis of the jet engine 100, which is parallel to the longitudinal axis of the aircraft 10 and oriented positively toward the front of the aircraft 10, Y denotes the transverse axis, which is horizontal when the aircraft 10 is on the ground, and Z denotes the vertical axis when the aircraft 10 is on the ground, these three axes X, Y and Z being mutually orthogonal.

FIG. 2 shows an exemplary embodiment of the invention in the case of a jet engine 100 of an aircraft 10. FIG. 2 shows a frontal view in cross section of the jet engine 100, which has an engine 102 forming a core around which an internal fixed structure 104 is arranged. Around a casing of the engine 102 there circulates an airflow taken from a bypass flow of the jet engine 100 in order to cool the engine 102 or a hot airflow taken from the engine 102 and the assembly formed by the internal fixed structure 104 and the engine 102 then behaves as a transport pipe for the airflow. The engine 102 constitutes a fluid jacket 102 which channels a flow of hot gas.

The internal fixed structure 104 is in the overall shape of a cylinder of revolution that is coaxial with the longitudinal axis X.

In the embodiment of the invention that is presented here, the internal fixed structure 104 is divided into two half-cylinders that are fixed at the top to the pylon 18 of the aircraft 10. The bottoms of the two half-cylinders are fixed to a structural element 20 of the jet engine 100.

The internal fixed structure 104 has an external wall 106 and an internal wall 108 that is coaxial with the external wall 106 and inside the external wall 106. The engine 102 is also mounted coaxially with the internal wall 108 and inside the latter.

The external wall 106 is preferably a wall made from a thermally insulating material, but may also be a structural wall of the internal fixed structure 104.

The external wall 106 and the internal wall 108 therefore constitute an outer tubular portion 106 and an inner tubular portion 108, respectively, which are mounted coaxially with one another and with the inner tubular portion 108 inside the outer tubular portion 106.

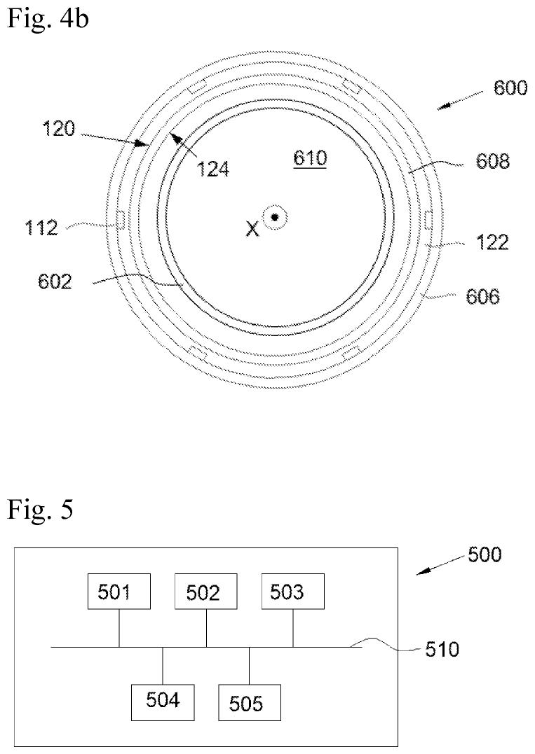

FIG. 4a shows another exemplary embodiment of the invention in the case of a pressurized pipe 400 that makes it possible, for example, to channel high-temperature air taken from the engine 102 or a cold fluid such as dihydrogen and is able to be installed in the aircraft 10, for example. In the embodiment of the invention presented in FIG. 4a, the pressurized fluid is channeled through a fluid jacket 402 in the form of a transport pipe 402 of the pipe 400.

The pipe 400 also has an outer tubular portion 406 and an inner tubular portion 408, which are mounted coaxially with one another and with the inner tubular portion 408 inside the outer tubular portion 406. The fluid jacket 402 is also mounted coaxially with the outer tubular portion 406 and with the inner tubular portion 408 and inside the latter.

The inner tubular portion 408 may be a wall made from a thermally insulating material.

FIG. 4b also shows another exemplary embodiment of the invention in the case of a storage tank 600 for a pressurized fluid in a cold state, in particular at a cryogenic temperature, such as dihydrogen, and able to be installed in the aircraft 10 for example. In the embodiment of the invention presented in FIG. 4b, the pressurized fluid is stored in the tank 600. The tank 600 has at least an outer tubular portion 606 and a fluid jacket 602, which are mounted coaxially with one another and with the fluid jacket 602 inside the outer tubular portion 606.

In the case of a dihydrogen storage tank 600, the fluid jacket 602 and the outer tubular portion 606 form double structural walls of the tank 600.

The tank 600 also has an inner tubular portion 608 mounted coaxially with the outer tubular portion 606 and with the inner tubular portion 608 inside the outer tubular portion 606. The fluid jacket 602 is mounted coaxially with the inner tubular portion 608 and inside the latter.

The inner tubular portion 608 may be a wall made from a thermally insulating material.

Generally, the invention relates to an assembly 100, 400, 600 comprising an outer tubular portion 106, 406, 606 and an inner tubular portion 108, 408, 608, which are mounted coaxially with one another and with the inner tubular portion 108, 408, 608 inside the outer tubular portion 106, 406, 606. In the embodiment of the invention presented in FIG. 2, the assembly 100 is the jet engine 100, in the embodiment in FIG. 4a, the assembly 400 is the pipe 400, and in the embodiment in FIG. 4b, the assembly 600 is the tank 600.

The different tubular portions 106, 406, 606, 108, 408, 608 are coaxial with respect to a central line X. In the case of the jet engine 100 or of the tank 600, the central line is coincident with the longitudinal axis X, and in the case of the pipe 400, which may have curves, the central line follows the curve of the centers of the tubular portions.

The assembly 100, 400, 600 also has a fluid jacket 102, 402, 602. The fluid contained in the fluid jacket 102, 402, 602 is at a first temperature.

In the case of the assembly 100 and for the pipe 400, the fluid jacket 102, 402 is a transport pipe in which a fluid circulates and which is mounted coaxially with the inner tubular portion 108, 408 and inside the latter. In the case of the double-wall dihydrogen storage tank 600, the fluid jacket 602 corresponds to the inner wall of the tank 600 in which the dihydrogen is stored, and is mounted coaxially with the outer tubular portion 606, which corresponds to the outer wall of the tank 600.

The outer tubular portion 106, 406, 606 delimits an inner space 110, 410, 610, which contains another fluid exhibiting a second temperature different from the first temperature of the fluid contained in the fluid jacket 102, 402, 602, and the assembly 100, 400, 600 has thermal flow sensors 112 (referred to as “sensors” below) that are distributed in this inner space 110, 410, 610 and fixed to the inner tubular portion 108, 408, 608 or to the outer tubular portion 106, 406, 606, this being the case here and more specifically to the inner surface of the outer tubular portion 106, 406, 606. The other fluid is thus contained in the inner tubular portion 108, 408, 608 about the fluid jacket 102, 402, 602.

The sensors 112 are preferably fixed to the outer tubular portion 106, 406, 606, which is structural here, and consequently rigid, rather than to the inner tubular portion 108, 408, 608, which has a thermal insulation function and may need to be replaced.

The sensors 112 may be fixed to the outer surface 120 of the inner tubular portion 108, 408, 608, that is to say, in a space 122 included in the inner space 110, 410, 610 and delimited between the inner tubular portion 108, 408, 608 and the outer tubular portion 106, 406, 606, or to the inner surface 124 of the inner tubular portion 108, 408, 608.

Each sensor 112 delivers a value that relates to the value of the thermal flow passing through it.

Each sensor 112 may be disposed in the vicinity of a potential leak of hot air from a system for supplying hot air taken from the engine 102.

According to one configuration, the first temperature of the fluid contained in the fluid jacket 102, 402, 602 is higher than the second temperature of the other fluid contained in the inner space 110, 410, 610 and therefore between the fluid jacket 102, 402, 602 and the inner tubular portion 108, 408, 608. In the event of a leak of the hot fluid from the fluid jacket 102, 402, 602 into the inner space 110, 410, 610, the sensor or sensors 112 in the vicinity of the leak will allow detection of the leak, since the value of the thermal flow passing through it or them will be different from the value of the thermal flow detected before the leak arises.

According to another configuration, each sensor 112 may be disposed in the vicinity of a potential leak of cold fluid from the fluid jacket 402, 602. According to this configuration, the first temperature of the fluid contained in the fluid jacket 402, 602 is lower than the second temperature of the inner space 410, 610. In the event of a leak of the cold fluid from the fluid jacket 402, 602 into the inner space 410, 610, the sensor or sensors 112 in the vicinity of the leak will allow detection of the leak, since the value of the thermal flow passing through it or them will be different from the value of the thermal flow detected before the leak arises.

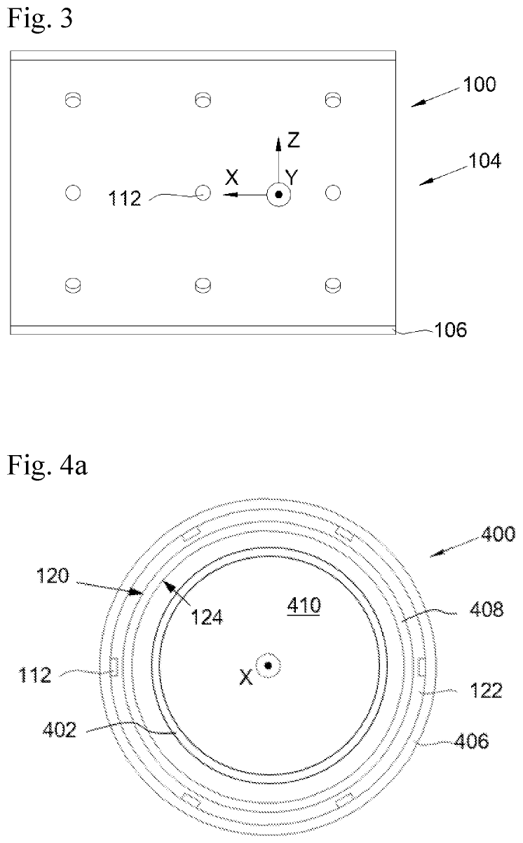

FIG. 3 shows the distribution of the sensors 112 along the central line X in the case of the jet engine 100 in FIG. 2, but this applies in the same way to the case of the pipe 400 in FIG. 4a or the tank in FIG. 4b. To make it possible to see the sensors 112, only the outer tubular portion 106 has been shown.

There are several groups of sensors 112, which are distributed along the central line X. Thus, for each group, there are at least four sensors 112 in the group and the sensors 112 of the group are disposed overall in one and the same plane perpendicular to the central line X. The distribution of the sensors 112 along the central line X makes it possible to cover the part of the assembly 100, 400, 600 which is subject to monitoring.

Around the central line X, the sensors 112 of the group are distributed angularly around the central line X and depending on the number of sensors 112 employed, the spacing between two consecutive sensors 112 varies angularly. Preferably, there are at least four sensors 112 per group, which will then be, for example, at 90° from one another around the central line. In the embodiments of the invention shown in FIG. 2, FIG. 4a and FIG. 4b, there are six sensors 112 per group and these sensors 112 are spaced at 60° from one another, but a different angular distribution is, of course, possible.

The particular installation of the sensors 112 makes it possible to have sections that are equipped with sensors 112 and distributed along the central line X and to cover the assembly 100, 400, 600 along the entire length equipped therewith. Each section thus corresponds to a group.

The assembly 100, 400, 600 also has a control unit is connected wirelessly or by a wired connection to each sensor 112 of each group in order to collect the value delivered by the sensor 112 at a time ‘t’. A wireless connection between the sensors 112 and the control unit makes it easier to move the sensors 112 and to add or replace the latter.

Depending on the thermal flows received by the different sensors 112 along the assembly 100, 400, 600, the control unit can determine whether one or more sensors 112 of a group is/are measuring disproportionate thermal flows compared with the other sensors of the same group, this possibly meaning that a problem has arisen at the fluid jacket 102, 402, 602.

On the basis of the values received, the control unit determines a warning level that relates to the assembly 100, 400, 600. There are for example four warning levels:
class 1: the conditions are normal,
class 2: the conditions are slightly abnormal, suggesting a latent leak from the fluid jacket 102, 402, 602 close to the sensor or sensors 112 having a disproportionate value compared with the others,
class 3: the conditions are very abnormal, suggesting an explosion caused by an overpressure close to the sensor or sensors 112 having a disproportionate value compared with the others, and
class 4: the conditions are extremely abnormal, suggesting the presence of an outbreak of fire close to the sensor or sensors 112 having a disproportionate value compared with the others.

Depending on the warning level, appropriate corrective measures can be taken, for example in-flight measures, maintenance measures for the slightly abnormal and very abnormal conditions, and verification and potentially extinguishing measures for the extremely abnormal conditions, for example the detection of an outbreak of fire close to the casing of the engine 102.

Thus, the assembly 100, 400, 600 allows continuous monitoring of the operating conditions with inexpensive sensors that are easy to employ and are lightweight compared with the elements of the prior art.

Moreover, the assembly 100, 400, 600 allows verification and correlation of the thermal simulation models used during tests of the assembly 100, 400, 600 during operation on the ground or in flight, and in the development phase.

According to one particular embodiment, the inner tubular portion 108, 408, 608 is made from a thermally insulating material. The thermally insulating material has a thermal conductivity of less than 0.2 Wm−1K−1, in particular around 0.04 Wm−1K−1. This makes it possible to protect the sensors 112 from potential direct hot-air jets, which may be at a temperature of up to around 650° C. This inner tubular portion thus makes it possible to improve the service life of the sensors 112, in particular if a hose ruptures or a fire breaks out. This also makes it possible to thermally protect the fluid jacket 102, 402, 602 and to reduce potential damaging thermal leaks from the fluid jacket 102, 402, 602 toward its external environment.

According to one particular embodiment, the assembly 100, 400, 600 has a plurality of inner tubular portions 108, 408, 608, the inner tubular portions 108, 408, 608 being disposed so as to cover the sensors 112 when the outer tubular portion 106, 406, 606 needs to be protected thermally from the thermal environment of the engine 102. For example, for an internal fixed structure, it may be necessary to thermally protect the internal fixed structure 104 from the hot thermal environment of the engine 102. In this case, the inner tubular portion 108, 408, 608 made of a thermally insulating material has a function of thermally protecting the outer tubular portion 106, 406, 606 and a function of thermally protecting the sensors 112. Moreover, the stray circumferential thermal flows in the inner tubular portion 108, 408, 608 made of thermally insulating material are weak, thereby increasing the precision of the measurements acquired by the sensors 112 and the precision of locating an abnormal fluid flow affecting the inner tubular portion 108, 408, 608.

FIG. 5 shows an example of a control unit 500 which has, connected by a communication bus 510: a processor 501 or CPU (central processing unit); a random access memory (RAM) 502; a read-only memory (ROM) 503; a storage unit such as a hard disk or a storage medium reader, such as an SD (secure digital) card reader 504; at least one communication interface 505 which allows the control unit to communicate with the sensors 112.

The processor is capable of executing instructions loaded into the RAM from the ROM, from an external memory (not shown), from a storage medium (such as an SD card), or from a communication network. When the equipment is powered up, the processor is capable of reading instructions from the RAM and executing them. These instructions form a computer program which causes the processor to implement all or some of the algorithms and steps described below.

All or some of the algorithms and steps described below may be implemented in software form through the execution of a set of instructions by a programmable machine, for example a DSP (digital signal processor) or a microcontroller, or may be implemented in hardware form by a machine or a dedicated component, for example an FPGA (field-programmable gate array) or ASIC (application-specific integrated circuit).

An example of a method for determining the warning level consists, for the control unit at a time ‘t’, in:
collecting, for each group of sensors 112, the value that relates to the thermal flow passing through each sensor 112 of the group at a time T and is transmitted by the sensor 112,
calculating, for each group, a so-called “group” average, which is the average of the values thus collected for the group,
for each group and for each sensor 112 of the group, calculating the difference between the value of the sensor 112 and the group average and the ratio between this difference and the group average,
for each group and for each sensor 112 of the group, classifying the warning level of the sensor 112 into a category depending on the ratio thus calculated for the sensor 112.

For example, to give orders of magnitude that can be altered depending on the calibration of the thermal simulation models during development tests, if the ratio is less than or equal to 30%, the corresponding sensor 112 is classified in class 1, if the ratio is in the range of 30% to 80%, the corresponding sensor 112 is classified in class 2, if the ratio is in the range 80% to 150%, the corresponding sensor 112 is classified in class 3, if the ratio is strictly greater than 150%, the corresponding sensor 112 is classified in class 4. Typically, this classification can be carried out after several successive temporal acquisitions, in order to increase the reliability of the calculations. For example, this classification can be carried out after three successive acquisitions, depending on the acquisition frequency of the sensors 112.

On the basis of this classification, the control unit informs the responsible person, for example the pilot in the case of the aircraft 10, who can then take the appropriate corrective measures. The responsible person can be informed in various ways, for example the display of a message on a screen, the sending of a message on a computer, a tablet or telephone, etc. The control unit can thus comprise display means that are disposed in the cockpit of the aircraft, or outside the aircraft.

The control unit 500 thus has:
collecting means which are intended to collect, for each group of sensors 112, the value that relates to the thermal flow passing through each sensor 112 of the group at the time ‘t’ and is transmitted by the sensor 112,
first calculation means which are intended to calculate, for each group, a so-called “group” average, which is the average of the values thus collected for the group,
second calculation means which are intended, for each group and for each sensor 112 of the group, to calculate the difference between the value of the sensor 112 and the group average and the ratio between this difference and the group average, and
classification means which are intended, for each group and for each sensor 112 of the group, to classify the warning level of the sensor 112 into a category depending on the ratio thus calculated for the sensor 112.

The control unit 500 also has transmission means intended to transmit the necessary information to the responsible person.

The control unit 500 is thus configured to analyze the data acquired by the sensors 112 in real time, but may also be configured to store these data and subsequently to allow these stored data to be analyzed.

In order that the drift or failure of a sensor 112 does not bring about erroneous warning levels or a lack of detection of an actual warning, the determination method is applied by taking out the minimum and maximum values collected for each group for calculating the average of the values collected for the group. The minimum value is considered to be representative of a drift or failure of a sensor 112, while the maximum value is considered to be representative of actual abnormal overheating.

Thus, between the collection of the values and the calculation of the group average, the determination method comprises determining, for each group, the maximum value and the minimum value of the values collected for the group and the calculation of the group average is then carried out on the basis of the set of values of the group without the maximum value and the minimum value thus determined.

In this embodiment, since a maximum value and a minimum value are taken out for the calculation of the value average, the number of sensors 112 per group is at least equal to four.

The control unit 500 thus has determination means which are intended to determine, for each group, the maximum value and the minimum value of the values thus collected for the group.

The first calculation means are then intended to calculate the group average on the basis of the set of values of the group without the maximum value and the minimum value thus determined.

To confirm the veracity of a warning level, the determination method is carried out several times in succession, in order to confirm that a warning level remains stable over time. According to one particular embodiment, the determination method is carried out three times in a row, for example at a frequency of 1 Hz.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An assembly in an aircraft, comprising:
an outer tubular portion centered on a central line and delimits an inner space,
an inner tubular portion mounted coaxially with the outer tubular portion and inside the outer tubular portion, wherein the inner tubular portion contains a fluid exhibiting a temperature referred to as “second temperature”,
a fluid jacket mounted coaxially with the outer tubular portion and inside the inner tubular portion, wherein the fluid jacket contains a fluid exhibiting a temperature referred to as “first temperature” and wherein the first temperature is different from the second temperature,
a plurality of groups of at least four thermal flow sensors, wherein, for each group, the sensors of said group are disposed in said inner space of the outer tubular portion and overall in one and the same plane perpendicular to the central line, and wherein, in each group, the sensors of said group are distributed angularly about the central line, and
a control unit which, for each group, receives data from each sensor of said group and which, based on these data, determines a warning level that relates to said assembly, the control unit having:
collecting means which are configured to collect, for each group of sensors, a value that relates to a thermal flow passing through each sensor of said group at a time ‘t’ and is transmitted by said sensor,
first calculation means which are configured to calculate, for each group, a group average, which is an average of values thus collected for said group,
second calculation means which are configured, for each group and for each sensor of said group, to calculate a difference between the value of said sensor and the group average and the ratio between this difference and the group average, and
classification means which are configured, for each group and for each sensor of said group, to classify the warning level of said sensor into a category depending on a ratio thus calculated for said sensor.

2. The assembly according to claim 1,
wherein the control unit has determination means which are configured to determine, for each group, a maximum value and a minimum value of the values collected for the group, and
wherein the first calculation means are configured to calculate the group average based on a set of values of the group without the maximum value and the minimum value.

3. The assembly according to claim 1, wherein the sensors are fixed to the inner tubular portion.

4. The assembly according to claim 1, wherein the inner tubular portion is made of a thermally insulating material with a thermal conductivity of less than 0.2 Wm−1K−1.

5. The assembly according to claim 1,
wherein said assembly is a jet engine of an aircraft,
wherein the fluid jacket is an engine channeling a flow of hot gas, and
wherein the outer tubular portion and the inner tubular portion respectively constitute an external wall and an internal wall of an internal fixed structure.

6. The assembly according to claim 1, wherein said assembly is a pipe, wherein the fluid jacket channels a pressurized fluid.

7. The assembly according to claim 1,
wherein said assembly is a storage tank for a pressurized fluid, and
wherein the fluid jacket is configured to contain a pressurized fluid.

8. An aircraft comprising at least one assembly according to claim 5.
